(19) United States
(12) Patent Application Publication
(10) Pub. No.: US 2008/0264549 A1
(43) Pub. Date: Oct. 30, 2008

(54) Method of forming a layer of puncture-repair seal in tire

(75) Inventor: Wen Chang Shih, Taipei (TW)

Correspondence Address: BIRCH STEWART KOLASCH & BIRCH, PO BOX 747, FALLS CHURCH, VA, 22040-0747, US

(73) Assignee: Hsiao, Tsung Chi ; Hsu, Kuang Hui

(21) Appl. No.: 11/797,051

(22) Filed: Apr. 30, 2007

(51) Int. Cl. B29C 73/16

(52) U.S. Cl. 156/115

(57) ABSTRACT

In a method of forming a layer of puncture-repair seal in tire, a PU gel consisting of polyisocyanate and polyether blending is prepared and evenly coated on an inner surface of a tire via a centrifugal force. When the tire rotating on road is pierced by a foreign matter, the puncture-repair seal of PU gel under a centrifugal force is able to ooze into a hole formed on the tire by the foreign matter to thereby prevent air in the tire from leaking. Since the layer of puncture-repair seal in the tire not only protects the tread but also side areas of the tire, a car with tires internally provided with the puncture-repair seal in the method of the present invention is safer for use.

### FIELD OF THE INVENTION

The present invention relates to a method of forming a layer of puncture-repair seal in tubeless tire, and more particularly to a technique of coating an elastic plastic material on an inner surface of a tire to function as a puncture-repair seal for tire, so that a hole formed on the tire by a foreign matter can be timely automatically filled by the seal to prevent a flat tire and ensure the safety in driving.

### BACKGROUND OF THE INVENTION

Taiwan Patent Publication No. 580463 discloses a technique for repairing a punctured tire as shown in FIG. 1. A seal chamber 6 is formed around an air chamber 5 in a tire T, and filled with a leakage-stop sealing agent 7. The sealing agent 7 has a viscosity within the range from 25 dPa·s to 35 dPa·s and a thixotropic coefficient within the range from 6.5 to 11.0. When the tire T rotates during car driving, the viscosity of the sealing agent 7 is reduced due to a stirring effect caused by vibration or centrifugal force, allowing the sealing agent 7 to evenly scatter in the seal chamber 6. On the other hand, when the tire T stops rotating and the stirring effect disappears, the viscosity of the sealing agent 7 is increased, enabling the sealing agent 7 to maintain the evenly scattered state without f lowing to a lower side of the seal chamber 6 due to gravity. Therefore, no vibration or noise would be produced when the car moves at high speed again from a still state. In brief, in a tire, there is provided a leakage-stop sealing agent that has low viscosity and is easy to flow when the tire is rotating, but high viscosity and uneasy to flow when the tire is still.

In the invention of Taiwan Patent Publication No. 580463, a lining 2L defining the seal chamber 6 and filled with the sealing agent 7 is produced and then internally bonded to a body 1 of the tire to form the tire T. Therefore, complicate process and high cost are required in manufacturing the tire T. It is therefore tried by the inventor to develop a method of forming a layer of puncture-repair seal in tire to overcome the disadvantages in the prior art.

### SUMMARY OF THE INVENTION

A primary object of the present invention is to provide a method of forming a layer of puncture-repair seal in tire, so as to prevent a flat tire caused by a puncture on the tire. The method may be used with both new and usable old tires, and may largely simplify the process and reduce the cost for forming a leak-stop structure on tire.

The method of forming a layer of puncture-repair seal in tire according to the present invention is characterized in the following points:
1. The puncture-repair seal can be easily and evenly coated on an inner surface of the tire via a centrifugal force to achieve the function of preventing a flat tire.
2. The layer of puncture-repair seal formed in the tire may be 2 to 20 mm in thickness. Therefore, the largest thickness of the puncture-repair seal layer is almost 4.4 times of that of the conventionally available similar structure, and can provide even better hole repairing and filling effect than the prior art.
3. Since the puncture-repair seal is centrifugally and evenly coated on the whole inner surface of the tire, it not only protects the tread of the tire, but also all other areas of the tire that is possibly subjected to unexpected puncture.

With the above advantages, the method of forming a layer of puncture-repair seal in tire according to the present invention is different from or superior to Taiwan Patent Publication No. 580463 (hereinafter referred to as the prior art) in the following aspects:

In the aspect of application: While the prior art is applicable to tires with and without inner tube, the present invention is particularly designed for tubeless tires.

In the aspect of adopted technical means: In the prior art, the lining 2L defining the seal chamber 6 and filled with the leakage-stop sealing agent 7 is first produced and then bonded to the tire body 1 to form the tire T. The prior art therefore involves in complicate process and high cost, and is only applicable to a new tire during manufacturing thereof. On the other hand, the method of the present invention may be used with either new or old tire, so long as the old tire is still in a usable condition.

In the aspect of available puncture-repair depth: The seal chamber 6 in the prior art has a radial thickness t about 1.2 mm+/−0.3 mm. That is, the seal chamber 6 is about 0.9 mm to 1.5 mm in thickness. Based on this size, the seal chamber 6 can only hold a very limited amount of sealing agent 7. When the tire T is pierced through by a somewhat big-volume pointed thing, such as a knife blade, a nail, etc., a relatively wide hole would be formed on the tire T. It is doubtful whether the limited amount of sealing agent 7 in the seal chamber 6 would be sufficient for filling and repairing the big hole, particularly when the tire T has a seriously worn-out or thinned tread. Even if the sealing agent 7 is sufficient for filling the hole, the repair effect thereof is possibly adversely reduced, particularly when the lining 2L has also been damaged by the pointed thing. On the other hand, the layer of puncture-repair seal formed in the method of the present invention is about 2 to 20 mm in thickness. Even the lowest thickness of 2 mm for the puncture-repair seal layer is far thicker than the highest thickness of 1.5 mm for the seal chamber 6 in the prior art. As estimated according to FIG. 1, the lining 2L might have an overall thickness three times as large as the thickness of the seal chamber 6, i.e. 1.5 mm×3=4.5 mm, which is very small compared with the maximum thickness of 20 mm for the puncture-repair seal of the present invention. Therefore, it can be easily determined the puncture-repair seal layer formed in the method of the present invention is functionally superior to the hole-repair structure disclosed in the prior art.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cross-sectional view showing a conventional technique of providing a leakage-stop structure in a tire;

FIG. 2 is a flowchart showing the steps included in a method of forming a layer of puncture-repair seal in tire according to the present invention;

FIG. 3 is a cross-sectional view of a tire with a puncture-repair seal layer formed therein according to the method of the present invention;

FIG. 4 shows the tire with the puncture-repair seal layer shown in FIG. 3 is punctured by a nail; and

FIG. 5 shows a hole formed on the tire by the nail is sealed by the puncture-repair seal to prevent the tire from leakage.

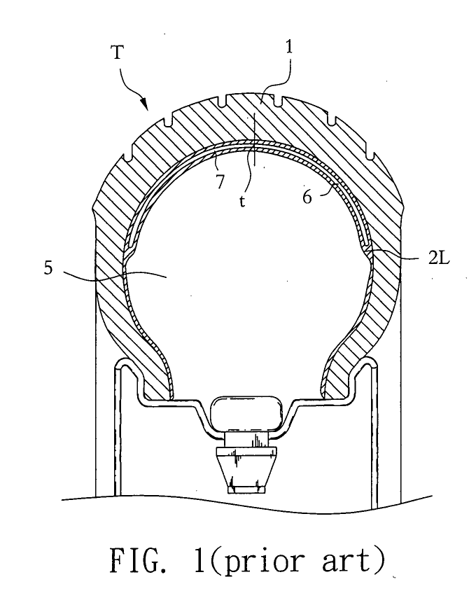

### DETAILED DESCRIPTION OF THE PREFERRED EMBODIMENTS

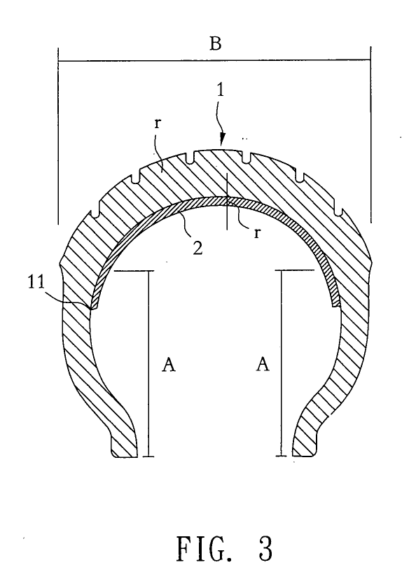

Please refer to FIG. 3 that is a cross-sectional view of a tire 1 with a layer of puncture-repair seal 2 formed on an inner surface 11 thereof according to a method of the present invention.

The puncture-repair seal 2 is formed of a PU (polyurethane) gel, which is an elastic plastic material consisting of polyisocyanate and polyether blending, and is a high-molecular material with low viscosity, good flow property, and good processing property. Some relevant physical properties of the PU gel are listed below:

| | Polyisocyanate | Polyether blending |
|---|---|---|
| Viscosity | 1000~3000 | 1000~5000 |
| (CPS/25° C.) | | |
| Density | 1.2 | 1.02 |
| (g/cm³) | | |
| Color | Yellowish | Clear |
| Blending Ratio | 0.1~0.4 | 1 |
| (Wt %) | | |

The polyether blending and the polyisocyanate are blended at a ratio of 1 to 0.1-0.4. That is, 10 to 40 g of polyisocyanate is evenly blended into 100 g of polyether blending to produce the PU get used to form the puncture-repair seal 2 used in the present invention. The puncture-repair seal 2 so formed and in a gelled state may endure a temperature range from −60° C. to +80° C., and may maintain stable physical properties thereof within this temperature range. Therefore, a finish product of the puncture-repair seal 2 provides a degree of viscoelasticity. The optimal blending ratio of the polyether blending to the polyisocyanate falls in 1:0.1-1:0.4. The obtained compound, that is, the PU gel for the puncture-repair seal 2, has low viscosity, good flow property, good processing property, and good elasticity. This type of puncture-repair seal 2 would deform or flow whenever it is subjected to stress or pressure, and therefore has enhanced hole sealing effect.

In an embodiment of the present invention, the polyisocyanate is diisocyanate. And, the diisocyanate includes two major types, one of which is aromatic isocyanate, which may include diphenylmethane-4,4 diisocyanate and the compounds thereof, and the other type is aliphatic isocyanate, which may include Xylenediisocyanate (XDI), Tetramethylenexylene Diisocyanate (TMXDI), Isophorpne diisocyanate (IPDI), and Hexamethylene diisocyanate (HDI).

In an embodiment of the present invention, the polyether blending consists of polyether polyol and polyester polyol, and has an O—H value within the range from 20 to 60.

The following table I shows detailed data about the physical properties and the processing property of the PU gel obtained from experimental tests conducted on it.

TABLE I

| Item | A | B | C | D |
|---|---|---|---|---|
| Components | Diisocyanate/ | Diisocyanate/ | Diisocyanate/ | Diisocyanate/ |
| | triol-5000~7000/ | triol-5000~7000/ | triol-5000~7000/ | triol-5000~7000/ |
| | plasticizer | plasticizer | mono-ol | mono-ol |
| Prepolymer | 6% | 6% | 10% | 10% |
| (NCO %) | | | | |
| Curing agent/ | triol-5000~7000/ | triol-5000~7000/ | triol-5000~7000/ | triol-5000~7000/ |
| Catalyst | plasticizer | plasticizer | mono-ol | mono-ol |
| Processing | 80 | 60 | 100 | 90 |
| parameters | | | | |
| Iso Index | | | | |
| Polyol viscosity | 1200~3200 | 1200~3200 | 1200~3200 | 1200~3200 |
| 25° C.(mPas) | | | | |
| Isocyanate | 1200~3200 | 1200~3200 | 1200~3200 | 1200~3200 |
| viscosity | | | | |
| 25° C.(mPas) | | | | |
| Mixing | 25~30 | 25~30 | 25~30 | 25~30 |
| temperature(° C.) | | | | |
| Curing time | 10~15 | 10~15 | 10~15 | 10~15 |
| (min/35° C.) | | | | |
| Physical | | | | |
| properties | | | | |
| Density | 1.03 | 1.02 | 1.07 | 1.06 |
| (g/cm³) | | | | |
| Hardness | 0 | 0 | 0 | 0 |
| (Shore A) | | | | |
| Hardness | 25~35 | 12~20 | 15~25 | 10~25 |
| (Shore 000) | | | | |
| Tensile (MPa)- | 0.6~1.6 | 0.06~0.8 | 0.1~1.2 | 0.08~1.0 |
| ASTM D412 | | | | |
| Elongation (%)- | 320~460 | 360~480 | 400~500 | 480~580 |
| ASTM D412 | | | | |
| Tear (kN/m)- | 2.0~3.0 | 1.2~2.6 | 1.6~3.2 | 1.2~2.8 |
| ASTM | | | | |
| D624 die C | | | | |

From the above Table I, it can be seen that the puncture repair seal 2 of PU gel used in the present invention has tensile force, elasticity, density, etc. that are always stable in tests conducted at different temperature conditions. For example, the elongation of the PU gel is 460%. It is found the PU gel still has a stable elongation of 460% when it is positioned in different environments at 70° C. and 100° C. for three weeks each.

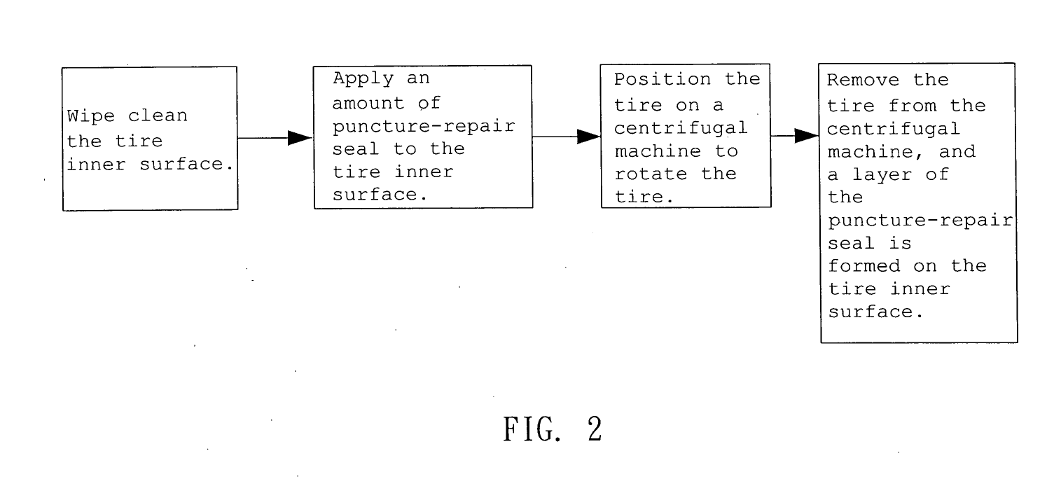

Please refer to FIGS. 2 and 3 at the same time. To coat the puncture-repair seal 2 on the inner surface 11 of the tire 1, first use a predetermined detergent to wipe the inner surface 11 of the tire 1, so as to effectively remove grease, oil, and other impurities from the inner surface 11, which serves as a contact surface between the tire 1 and the puncture-repair seal 2. Then, position the tire 1 on a centrifugal machine (not shown), and apply an amount of the PU gel at a point on the inner surface 11 of the tire 1 for forming a layer of puncture-repair seal 2 latter. Thereafter, turn on the centrifugal machine for the tire 1 to rotate at a speed about 300 to 2000 rpm/min for 10 to 20 minutes. The steps of applying the PU gel and rotating the tire 1 are performed at room temperature of 25° C. The PU gel is evenly spread and coated on the whole inner surface 11 of the tire 1 under a centrifugal force when the tire 1 is rotated. Finally, remove the tire 1 from the centrifugal machine, and a layer of puncture-repair seal 2 of PU gel having a radial thickness r about 2 to 20 mm has been evenly coated on the inner surface 11 of the tire 1.

While the layer of puncture-repair seal 2 of PU gel is only a few millimeters in thickness, it provides the required tire repair function without adversely influencing the performance and function of the tire 1. Since the tire 1 internally provided with the puncture-repair seal 2 maintains a hollow structure, it provides relatively good elasticity and accordingly, good shock-absorbing effect.

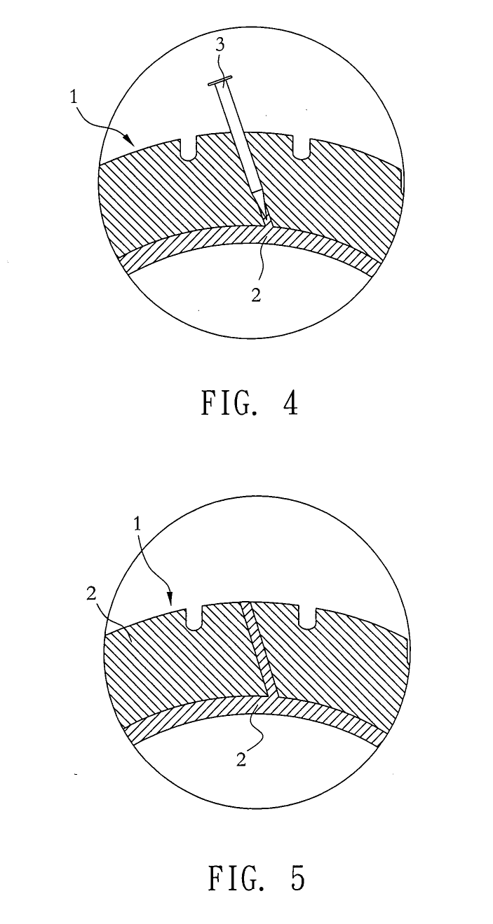

When the tire 1 in rotating is undesirably pierced by a foreign matter 3, such as a nail, to form a hole as shown in FIG. 4, the puncture-repair seal 2 rotated along with the tire 1 is thrown by a centrifugal force produced by the rotating tire 1 to ooze into the hole to tightly adhere to areas surrounding the foreign matter 3 and firmly fill any clearance between the tire 1 and the foreign matter 3, protecting the tire 1 against gradual leakage of internal air pressure thereof.

Please refer to FIG. 5. When the foreign matter 3 is extracted from the tire 1, the viscous puncture-repair seal 2 adhered to the foreign matter 3 is pulled outward along with the extracted foreign matter 3, making the hole formed on the tire 1 by the foreign matter 3 be closely filled with the puncture-repair seal 2, and a flat tire 1 is prevented. Being compressed by air in the hollow tire 1, the puncture-repair seal 2 automatically fill the hole formed by the foreign matter 3 to provide a self-repair function.

What is claimed is:

1. A method of forming a layer of puncture-repair seal in tire, comprising the steps of:
(a) wiping clean an inner surface of a tire;
(b) applying an amount of a puncture-repair seal to any position on the inner surface of the tire;
(c) positioning the tire on a centrifugal machine to rotate the tire at a predetermined speed for a predetermined time period; and
(d) removing the tire from the centrifugal machine, and a layer of the puncture-repair seal having been evenly coated on the inner surface of the tire.

2. The method of forming a layer of puncture-repair seal in tire as claimed in claim 1, wherein, in the step (c), the tire on the centrifugal machine is rotated at a speed from about 300 to about 2000 rpm/min for 3 to 15 minutes.

3. The method of forming a layer of puncture-repair seal in tire as claimed in claim 2, wherein the centrifugal machine is operated at a room temperature from 25 to 30° C.

4. The method of forming a layer of puncture-repair seal in tire as claimed in claim 1, wherein, in the step (d), the layer of the puncture-repair seal coated on the inner surface of the tire is 2 to 20 mm in thickness.

5. The method of forming a layer of puncture-repair seal in tire as claimed in claim 1, wherein the puncture-repair seal is prepared by reacting polyisocyanate with polyether blending.

6. The method of forming a layer of puncture-repair seal in tire as claimed in claim 5, wherein the polyisocyanate is diisocyanate.

7. The method of forming a layer of puncture-repair seal in tire as claimed in claim 6, wherein the diisocyanate includes two major types, one of which is aromatic isocyanate, which may include diphenylmethane-4,4 diisocyanate and the compounds thereof, and the other type is aliphatic isocyanate, which may include Xylenediisocyanate (XDI), Tetramethylenexylene Diisocyanate (TMXDI), Isophorpne diisocyanate (IPDI), and Hexamethylene diisocyanate (HDI).

8. The method of forming a layer of puncture-repair seal in tire as claimed in claim 5, wherein the polyether blending consists of polyether polyol and polyester polyol, and has an O—H value within the range from 20 to 60.
